(19) United States
(12) Patent Application Publication
(10) Pub. No.: US 2023/0265277 A1
(43) Pub. Date: Aug. 24, 2023

(54) RESIN COMPOSITION FOR EASILY DYEABLE SYNTHETIC FIBERS, AND SYNTHETIC FIBER EASILY DYEABLE WITH ACIDIC DYE

(71) Applicant: KANEKA CORPORATION, Osaka (JP)

(72) Inventors: Sho SAKATA, Hyogo (JP); Tomomichi HASHIMOTO, Hyogo (JP)

(73) Assignee: KANEKA CORPORATION, Osaka (JP)

(21) Appl. No.: 18/043,531

(22) PCT Filed: Jun. 8, 2021
(86) PCT No.: PCT/JP2021/021807

§ 371 Date: Feb. 28, 2023

(30) Foreign Application Priority Data
Sep. 1, 2020 (JP) 2020-146923
Mar. 23, 2021 (JP) 2021-048625

(51) Int. Cl. C08L 27/06; D01F 6/40; D06P 3/74; D06P 3/82

(52) U.S. Cl. CPC C08L 27/06; D01F 6/40; D06P 3/74; D06P 3/8261; C08L 2205/02; D10B 2401/14; D10B 2503/08; D10B 2501/042; D10B 2321/101

(57) ABSTRACT

In one or more embodiments, the present invention relates to a resin composition containing at least a polymer (A) and a polymer (B), in which the polymer (A) is a polymer that includes one or more monomers selected from the group consisting of acrylonitrile, vinyl halides, and vinylidene halides, the polymer (B) is a polymer that is soluble in benzyl alcohol, and the resin composition contains the polymer (A) in an amount of 70 parts by mass or more and 92.5 parts by mass or less, and the polymer (B) in an amount of 7.5 parts by mass or more and 30 parts by mass or less, where a total amount of the polymer (A) and the polymer (B) is 100 parts by mass. Provided are synthetic fibers that are easily dyeable with an acidic dye without requiring use of a special facility or heating to high temperatures.

### TECHNICAL FIELD

The present invention relates to a resin composition that is easily dyeable with a dye, in particular, an acidic dye, a method for dyeing the same, synthetic fibers obtained using the resin composition, a method for producing synthetic fibers, and a hair ornament product containing synthetic fibers.

### BACKGROUND ART

Generally, fibers for artificial hair are dyed in a predetermined color at a fiber manufacturer or processing factory, and consumers use the shipped textile products in the ready-made color, and thus the consumers demand high coloring properties.

Patent Document 1 discloses acrylic composite fibers whose coloring properties are enhanced by using cellulose acetate and a cationic dye.

### PRIOR ART DOCUMENTS

### Patent Document

[Patent Document 1] JP H5-302213A

### DISCLOSURE OF INVENTION

### Problem to be Solved by the Invention

In recent years, consumers have various color preferences, there is demand for fibers for artificial hair with various colors, and especially, there is demand for fibers for artificial hair that can be easily dyed by consumers. However, it is difficult to sufficiently dye fibers to a desired color even when a commercially-available dyeing agent (acidic dye) for human hair is applied to synthetic fibers. Also, special equipment and heating at high temperatures are required in order to dye artificial hair to a desired color, and there is demand for fibers for artificial hair that is easily dyeable using a commercially-available dyeing agent for human hair without requiring a special facility or heating at high temperatures.

In view of this, in order to resolve the above-described conventional issues, the present invention provides a resin composition that is easily dyeable even when using a dyeing agent containing an acidic dye without requiring a special facility or heating at high temperatures, a method for dyeing the resin composition, synthetic fibers obtained using the resin composition, a method for producing synthetic fibers, and a hair ornament product containing synthetic fibers.

### Means for Solving Problem

In one or more embodiments, the present invention relates to a resin composition containing a polymer (A) and a polymer (B), in which the polymer (A) is a polymer that includes one or more monomers selected from the group consisting of acrylonitrile, a vinyl halide, and a vinylidene halide, the polymer (B) is a polymer that is soluble in benzyl alcohol, and the resin composition contains the polymer (A) in an amount of 70 parts by mass or more and 92.5 parts by mass or less, and the polymer (B) in an amount of 7.5 parts by mass or more and 30 parts by mass or less, where a total amount of the polymer (A) and the polymer (B) is 100 parts by mass.

In one or more embodiments, the present invention relates to a method for dyeing a resin composition, the method including coloring the resin composition by impregnating the resin composition with a dyeing agent containing a dye (C) and an alcohol.

In one or more embodiments, the present invention relates to a synthetic fiber containing the resin composition.

Further, in one or more embodiments, the present invention relates to a method for producing synthetic fibers, the method including melt-spinning the resin composition.

Also, in one or more embodiments, the present invention relates to a hair ornament product containing the synthetic fiber.

### Effects of the Invention

According to the present invention, it is possible to provide a resin composition that is easily dyeable with a dyeing agent containing an acidic dye, and a method for dyeing the resin composition.

Also, according to the present invention, it is possible to provide synthetic fibers that are easily dyeable with a dyeing agent containing an acidic dye, a method for producing the synthetic fibers, and a hair ornament product containing the synthetic fibers.

### DESCRIPTION OF THE INVENTION

The inventors of the present invention conducted intensive studies in order to resolve the above-described issues. As a result, the inventors of the present invention found that it is possible to easily dye, using a dyeing agent for human hair that contains an acidic dye, a resin composition containing; a polymer (A) that contains one or more monomer units selected from the group consisting of acrylonitrile, a vinyl halide, and a vinylidene halide; and a polymer (B) that is soluble in an alcohol, in particular, benzyl alcohol, in predetermined amounts, and synthetic fibers made from the resin composition, and to provide synthetic fibers for artificial hair having favorable dyeability, completing the present invention. In particular, the inventors of the present invention found that synthetic fibers made from a resin composition containing a polymer that contains, as the polymer (B) that is soluble in benzyl alcohol, one or more monomer units selected from the group consisting of vinyl acetate, vinylpyrrolidone, acrylic acid esters, methacrylic acid esters, and styrene, is easily dyeable using a dyeing agent for human hair that contains an acidic dye, and synthetic fibers for artificial hair having favorable dyeability can be provided, completing the present invention.

Dyeing Agent

The resin composition according to one or more embodiments of the present invention or synthetic fibers formed from the resin composition can be dyed using a dyeing agent containing a dye (C) and an alcohol. It is possible to use, as a dyeing agent, generally-used dyeing agents for human hair. There is no particular limitation on the dye (C), and examples of the dye (C) include acidic dyes, basic dyes, and disperse dyes. Specifically acidic dyes are preferable. An “acidic dye” refers to a water-soluble dye having an acidic group such as a sulfone group or a carboxyl group in its molecule.

Because the resin composition or the synthetic fibers made from the resin composition contains the polymer (B) that is soluble in benzyl alcohol, the resin composition or the synthetic fibers made from the resin composition is easily dyeable even when a dyeing agent for human hair containing an acidic dye is used. Although the reason therefor is not clear and can only be guessed, it is presumed that, when fibers are to be dyed, a dye and an alcohol, in particular, an alcohol contained in a dyeing agent containing benzyl alcohol, causes the polymer (B) to swell, as a result of which, the dye (in particular, an acidic dye) permeates into the resin and remains in the resin even after the resin is washed with water. Therefore, the resin composition or the synthetic fibers made from the resin composition can be dyed. It is possible to dye a resin composition or synthetic fibers by applying a dyeing agent for human hair that contains an acidic dye and leaving the resin composition or synthetic fibers for a predetermined period of time at room temperature (25±5° C.) without requiring a special facility or heating at high temperatures, for example.

There is no particular limitation on the acidic dye, and examples thereof include Red No. 106, Red No. 201, Red No. 227, Yellow No. 4, Yellow No. 5, Yellow No. 203, Yellow No. 403, Yellow No. 406, Blue No. 1, Orange No. 205, Violet No. 401, and Black No. 401.

There is no particular limitation on the alcohol, and examples thereof include ethanol, 1-propanol, 2-propanol, benzyl alcohol, 2-(benzyloxy)ethanol, 2-phenylethyl alcohol, cinnamyl alcohol, phenylpropanol, phenoxyethanol, and α-methylbenzyl alcohol. Benzyl alcohol is particularly preferable.

There is no particular limitation on the dyeing agent for human hair including commercially-available dyeing agents for human hair, and it is possible to use dyeing agents in various forms such as cream, gel, and foam.

A dyeing agent such as a dyeing agent for human hair may contain an organic solvent other than the alcohol, a cationic polymer, a surfactant, an oily component such as a silicone derivative, a thickening agent such as hydroxypropyl methylcellulose, hydroxyethyl cellulose, or xanthan gum, a flavor, an antiseptic agent, an antioxidant, an ultraviolet absorbing agent, a sequestering agent, a propellant, and a pearlizing agent.

Polymer (B)

There is no particular limitation on the polymer (B) as long as it is a polymer soluble in an alcohol, in particular, benzyl alcohol. In one or more embodiments of the present invention, the wording “soluble in benzyl alcohol” indicates that, when 0.1 g of a polymer is introduced into 5 mL of benzyl alcohol and stirred for 1 hour at room temperature (25±5° C.), solid content such as turbidity is not visually observed and a homogeneous and transparent solution can be obtained. The polymer (B) is preferably a polymer that includes one or more monomer units selected from the group consisting of vinyl acetate, vinylpyrrolidone, acrylic acid esters, methacrylic acid esters, and styrene.

From the viewpoint of dyeability and melt processability, the mass average molecular weight (Mw) of the polymer (B) is preferably 5000 or more and 300000 or less, and more preferably 10000 or more and 200000 or less.

Examples of the polymer having a vinyl acetate monomer unit include homopolymers of vinyl acetate, or copolymers of vinyl acetate and one or more other monomer units selected from the group consisting of acrylonitrile, vinylpyrrolidone, acrylic acid esters, and methacrylic acid esters. Specifically, from the viewpoint of dyeability, homopolymers constituted by vinyl acetate and copolymers of vinyl acetate and other monomer units are preferable, homopolymers constituted by vinyl acetate (poly(vinyl acetate)) and/or copolymers of vinylpyrrolidone and vinyl acetate are more preferable, and copolymers of vinylpyrrolidone and vinyl acetate are particularly preferable. There is no particular limitation on poly(vinyl acetate), and from the viewpoint of dyeability and melt processability, the number-average degree of polymerization thereof is preferably 100 or more and 3000 or less, and more preferably 500 or more and 2000 or less.

The vinyl acetate content is preferably 30 parts by mass or more when the total mass of vinyl acetate and other monomer units in a copolymer of vinyl acetate and the other monomer units is 100 parts by mass.

Examples of the polymer having methacrylic acid ester monomer unit include homopolymers of monomer units such as methyl methacrylate, ethyl methacrylate, n-butyl methacrylate, 2-hydroxyethyl methacrylate, and glycidyl methacrylate, and copolymers of one or more of these monomer units as main components. In particular, from the viewpoint of dyeability, homopolymers constituted by glycidyl methacrylate (poly(glycidyl methacrylate)) are preferable.

Polymer (A)

The polymer (A) is a homopolymer or a copolymer that contains one or more monomers selected from the group consisting of acrylonitrile, vinyl halides, and vinylidene halides.

Examples of the vinyl halides include vinyl chloride, vinyl bromide, and vinyl iodide. Examples of the vinylidene halides include vinylidene chloride, vinylidene bromide, and vinylidene iodide. These may be used alone or in combination of two or more. From the viewpoint of heat resistance, it is preferable to use vinyl chloride and/or vinylidene chloride, and more preferably use vinyl chloride.

From the viewpoint of melt processability and fiber physical properties, the mass average molecular weight (Mw) of the polymer (A) is preferably 10000 or more and 300000 or less, and more preferably 30000 or more and 150000 or less.

The polymer (A) is preferably a modacrylic resin and/or a polyvinyl chloride from the viewpoint of the texture of fibers for artificial hair.

Modacrylic Resin

A modacrylic resin is a copolymer that contains acrylonitrile and one or more halogenated monomers selected from the group consisting of vinyl halides and vinylidene halides.

The above-described vinyl halides and vinylidene halides may be used as appropriate. From the viewpoint of heat resistance, it is preferable to use vinyl chloride and/or vinylidene chloride, and more preferably use vinyl chloride as a halogenated monomer.

It is preferable that the modacrylic resin contains acrylonitrile in an amount of parts by mass or more and 85 parts by mass or less and a halogenated monomer in an amount of 15 parts by mass or more and 65 parts by mass or less, where the total mass of acrylonitrile and the halogenated monomer is 100 parts by mass.

From the viewpoint of melt processability, the modacrylic resin is a copolymer of acrylonitrile, a halogenated monomer, and a macromonomer having, as the main chain, a polymer composed of a double bond-containing ethylenically unsaturated monomer, and when the total mass of the acrylonitrile, the halogenated monomer, and the macromonomer having, as the main chain, the polymer composed of the double bond-containing ethylenically unsaturated monomer (simply referred to as “macromonomer” hereinafter) is 100 parts by mass, the macromonomer content is preferably 1 part by mass or more and 30 parts by mass or less, it is more preferable that the acrylonitrile content is 35 parts by mass or more and 64 parts by mass or less, the halogenated monomer content is 35 parts by mass or more and 64 parts by mass or less, and the macromonomer content is 1 part by mass or more and 30 parts by mass or less, it is even more preferable that the acrylonitrile content is 35 parts by mass or more and 59 parts by mass or less, the halogenated monomer content is 40 parts by mass or more and 64 parts by mass or less, and the macromonomer content is 1 part by mass or more and 20 parts by mass or less, and it is particularly preferable that the acrylonitrile content is 35 parts by mass or more and 54 parts by mass or less, the halogenated monomer content is 45 parts by mass or more and 64 parts by mass or less, and the macromonomer content is 1 part by mass or more and 15 parts by mass or less.

Generally, the macromonomer refers to an oligomer molecule having a reactive functional group at an end of the polymer. The macromonomer has, an allyl group, a vinylsilyl group, a vinyl ether group, a dicyclopentadienyl group, and a group having a polymerizable carbon-carbon double bond represented by general formula (1) as a reactive functional group (also referred to as a polymerizable functional group), and the macromonomer has at least one such reactive functional group per molecule arranged at an end of the molecule. The macromonomer can usually be produced through radical polymerization. In particular, because acrylonitrile and halogenated monomers such as vinyl chloride have good reactivity, the reactive functional group in the macromonomer preferably has a polymerizable carbon-carbon double bond represented by the general formula (1) below.

CH₂═C(R)—C(O)O— (1)

In the general formula (1), R represents hydrogen or a substituted or unsubstituted alkyl group having 1 to 20 carbon atoms. There is no particular limitation on specific examples of R, and R preferably represents, for example, a group selected from the group consisting of —H, —CH₃, —CH₂CH₃, —(CH)ₙCH₃ (n represents an integer of 2 to 19), —C₆H₅, —CH₂OH, and —CN, and more preferably represents a group selected from the group consisting of —H and —CH₃. Specifically, poly(acrylic acid 2-methoxyethyl) macromonomers having a acryloyl group in one terminal of its, or the like may be used.

Note that a range indicated by “ . . . to . . . ” is the same as a range indicated by “ . . . or more and . . . or less” in this specification.

There is no particular limitation on a method for producing a polymer composed of a double bond-containing ethylenically unsaturated monomer, which is the main chain of the macromonomer, and a conventionally known production method can be used. JP 2006-299240A discloses detailed methods for producing macromonomers used in one or more embodiments of the invention, for example. Although any of these production methods may be used, usually, controlled radical polymerization is used, and living radical polymerization is preferably used from the viewpoint of performing a control with ease, and atom transfer radical polymerization is particularly preferable.

There is no particular limitation on the polymer composed of a double bond-containing ethylenically unsaturated monomer in the main chain of the macromonomer, and various double bond-containing ethylenically unsaturated monomers can be used as the double bond-containing ethylenically unsaturated monomer that constitutes the polymer. Examples thereof include (meth)acrylic acid ester-based monomers, styrene-based monomers, nitrile group-containing vinyl-based monomers, amide group-containing vinyl-based monomers, fluorine-containing vinyl monomers, silicon-containing vinyl monomers, maleimide-based monomers, vinyl esters, alkenes, and conjugated dienes. It is also possible to use maleic anhydride, maleic acid, monoalkyl esters of maleic acid and dialkyl esters of maleic acid; fumaric acid, monoalkyl esters of fumaric acid and dialkyl esters of fumaric acid; allyl chloride, allyl alcohol, and the like.

Method for Producing Modacrylic Resin

Copolymerization in an aqueous medium is preferable as a method for producing a modacrylic resin because polymerization can be easily controlled, and polymer particles can be easily separated and cleaned after polymerization. Examples of the polymerization method in an aqueous medium include production methods such as a suspension polymerization method, a microsuspension polymerization method, and an emulsion polymerization method. In particular, from the viewpoint of polymerization stability, the suspension polymerization method or the microsuspension polymerization method is preferable, and the suspension polymerization method is more preferable in order to obtain a modacrylic resin having an average particle size of 1 μm or more and 1000 μm or less.

In the suspension polymerization method or the microsuspension polymerization method, a thermoplastic modacrylic resin can be obtained in the form of a latex or slurry. There is no particular limitation on the method for drying the obtained modacrylic resin and obtaining a powdery copolymer resin, and examples thereof include a method for dehydrating the latex or slurry and drying the dehydrated latex or slurry through static drying using a hot-air dryer or the like.

In the suspension polymerization method or the microsuspension polymerization method, the above-described monomer, and a suspension dispersant, a polymerization initiator, a chain transfer agent, and the like are mixed all at once, or separately or continuously as needed, and copolymerized at a predetermined polymerization temperature of 25° C. or more and 100° C. or less, for example.

It is possible to use, as the suspension dispersant, partially saponified polyvinyl acetate; water-soluble cellulose ethers such as methyl cellulose, hydroxyethyl cellulose, hydroxypropyl cellulose, hydroxypropyl methylcellulose, and carboxymethylcellulose; polyethylene oxide; polyvinylpyrrolidone; polyacrylic acid; vinyl acetate-maleic acid copolymers; styrene-maleic acid copolymer; gelatin; organic macromolecular dispersant such as starch, for example. These may be used alone or in combination of two or more.

There is no particular limitation on the polymerization initiator, and an oil-soluble polymerization initiator having a 10-hour half-life temperature of 30° C. to 65° C. is preferably used. Examples of such oil-soluble polymerization initiators include organic peroxide-based polymerization initiators such as diisobutyl peroxide, cumyl peroxyneodecanoate, diisopropyl peroxydicarbonate, di(2-ethylhexyl)peroxydicarbonate, t-butyl peroxypivalate, t-butylperoxyneodecanoate, 1,1,3,3-tetramethylbutyl peroxyneodecanoate, dilauroyl peroxide, and di(3,5,5-trimethylhexanoyl) peroxide. These oil-soluble polymerization initiators may be used alone or in combination of two or more. Although these oil-soluble polymerization initiators can be added without any particular restrictions, if an oil-soluble polymerization initiator is to be dissolved in an organic solvent for use, examples of the organic solvent include aromatic hydrocarbons such as toluene, xylene, and benzene; aliphatic hydrocarbons such as hexane and isoparaffin; ketones such as acetone and methyl ethyl ketone; and esters such as ethyl acetate, butyl acetate, and dioctyl phthalate. These organic solvents may be used alone or in combination of two or more.

There is no particular limitation on the chain transfer agent, and thiol-based chain transfer agents are preferably used. Examples of such thiol-based chain transfer agents include ethanethiol, 1-propanethiol, 1-butanethiol, 1-octanethiol, 1-decanethiol, 1-dodecanethiol, 1-hexadecanethiol, 1-octadecanethiol, cyclohexanethiol, benzenethiol, allyl mercaptan, 2-mercaptoethanol, α-thioglycerol, thioglycolic acid, methyl thioglycolate, ethyl thioglycolate, 2-aminoethanethiol, sodium 2-mercaptoethanesulfonate, 4-nitrobenzenthiol, and cysteine.

During polymerization, a surfactant, a dispersing aid, an antioxidant, a polymerization degree modifier, a particle size modifier, a pH modifier, a gelation property improving agent, an antistatic agent, a stabilizer, a scale inhibitor, and the like can be used as appropriate.

Polyvinyl Chloride

Polyvinyl chloride is a homopolymer consisting of vinyl chloride, or a vinyl chloride-based copolymer containing vinyl chloride as the main component. In a vinyl chloride-based copolymer, examples of monomers copolymerizable with vinyl chloride (also referred to as “other monomers” hereinafter) include, but are not particularly limited to, vinyl esters such as vinyl acetate and vinyl propionate, acrylic acid esters such as butyl acrylate and 2-ethylhexyl acrylate, olefins such as ethylene and propylene.

The vinyl chloride content is preferably 70 parts by mass or more where the total mass of vinyl chloride and the other monomers in the vinyl chloride-based copolymer is 100 parts by mass.

It is possible to use the method disclosed in JP 115-140205A as a method for producing a polyvinyl chloride, for example.

Resin Composition

In one or more embodiments of the present invention, the resin composition contains the polymer (A) and the polymer (B). The resin composition may contain other polymers in addition to the polymer (A) and the polymer (B) within a range in which effects of the present invention are not impaired. Examples of the other polymers include polymers containing acrylic acid esters or methacrylic acid esters. The amount of the other polymers may be 20 parts by mass or less, where the total amount of the polymer (A) and the polymer (B) is 100 parts by mass.

From the viewpoint of melt processability and dyeability (in particular, dyeability of a dyeing agent containing an acidic dye), when the total amount of the polymer (A) and the polymer (B) is 100 parts by mass, the resin composition contains the polymer (A) in an amount of 70 parts by mass or more and 92.5 parts by mass or less, and the polymer (B) in an amount of 7.5 parts by mass or more and 30 parts by mass or less, and preferably contains the polymer (A) in an amount of 80 parts by mass or more and 90 parts by mass or less and the polymer (B) in an amount of 10 parts by mass or more and 20 parts by mass or less.

The resin composition may be obtained by blending a plasticizer, which is an organic compound that is compatible with the polymer (A) and has a boiling point of 200° C. or more, (simply referred to as “plasticizer”), into the polymer (A) and the polymer (B). The wording “compatible” used in this specification indicates that, when 10 mg of a polymer and 2 g of an organic compound having a boiling point of 200° C. or more are introduced into a 19-mL glass tube made of borosilicate glass, the glass tube is sealed with a silicon stopper, and the resulting mixture is then heated at 160° C. for 30 minutes while being stirred occasionally, the polymer is dissolved. Also, a “boiling point” used in this specification refers to a normal boiling point under the condition of 1 atmospheric pressure (760 mmHg).

There is no particular limitation on the plasticizer as long as it is an organic compound that is compatible with the polymer (A) and has a boiling point of 200° C. or more. It is possible to use, for example, sulfone-based compounds such as dimethyl sulfone, diethyl sulfone, dipropyl sulfone, dibutyl sulfone, diphenyl sulfone, vinyl sulfone, ethyl methyl sulfone, methyl phenyl sulfone, methyl vinyl sulfone, 3-methylsulfolane; sulfoxide-based compounds such as dipropyl sulfoxide, tetramethylene sulfoxide, diisopropyl sulfoxide, methylphenyl sulfoxide, dibutyl sulfoxide, diisobutyl sulfoxide, di-p-tolyl sulfoxide, diphenyl sulfoxide, and benzyl sulfoxide; lactides such as lactide; lactams such as pyrrolidone, N-vinylpyrrolidone, ε-caprolactam, and N-methylcaprolactam; lactones such as γ-butyrolactone, γ-hexalactone, γ-heptalactone, γ-octalactone, ε-caprolactone, and ε-octalactone. Also, these plasticizers may be used alone or in combination of two or more.

When fibers are kept at a temperature higher than the melting point of the plasticizer, the plasticizer may liquefy and ooze out on the fiber surface, which deteriorates the appearance and texture of the fibers. When the temperature returns to room temperature (25±5° C.), the plasticizer becomes solid and tends to cause the problem of sticking between fibers. In particular, the indoor temperature may increase to 60° C. in an onboard container during overseas transportation, and the indoor temperature may increase to 90° C. during fiber processing, albeit for a short period of time. Therefore, the melting point of the plasticizer is preferably 60° C. or more and more preferably 90° C. or more. It is preferable to use one or more selected from the group consisting of dimethyl sulfone, lactide, ε-caprolactam, and it is more preferable to use one or more selected from the group consisting of dimethyl sulfone and lactide, for example.

From the viewpoint of melt processability, the resin composition preferably contains the plasticizer in an amount of 0.1 parts by mass or more and 50 parts by mass or less with respect to 100 parts by mass of the total amount of the polymer (A) and the polymer (B). When the blend amount of the plasticizer is 50 parts by mass or less, melt processability is favorable and the resin viscosity during melt kneading is improved. Therefore, kneading efficiency tends to be improved. From the viewpoint of heat resistance, the resin composition preferably contains the plasticizer in an amount of 30 parts by mass or less, more preferably contains 25 parts by mass or less, even more preferably 20 parts by mass or less, and particularly preferably 15 parts by mass or less, with respect to 100 parts by mass of the total amount of the polymer (A) and the polymer (B). From the viewpoint of melt processability, the resin composition preferably contains the plasticizer in an amount of 0.5 parts by mass or more, more preferably 1 part by mass or more, and even more preferably 2.5 parts by mass or more, with respect to 100 parts by mass of the total amount of the polymer (A) and the polymer (B). When dimethyl sulfone is used and the amount of dimethyl sulfone is 2.5 parts by mass or more, for example, melt processability is favorable. When 20 parts by mass of dimethyl sulfone is mixed, it is possible to perform melt processing even at a low temperature, e.g., 115° C., which is 5° C. higher than the melting point of dimethyl sulfone, for example.

The resin composition may further contain a stabilizer for thermal stability. There is no particular limitation on the stabilizer as long as it imparts thermal stability. From the viewpoint of suppressing coloration and ensuring transparency while improving melt processability, the stabilizer is preferably one or more selected from the group consisting of epoxy-based heat stabilizers, hydrotalcite-based heat stabilizers, tin-based heat stabilizers, Ca—Zn-based heat stabilizers, and β-diketone-based heat stabilizers.

It is possible to use, as an epoxy-based heat stabilizer, a homopolymer, a copolymer, or the like of one or more vinyl monomers selected from the group consisting of butyl glycidyl ether, neopentyl glycol diglycidyl ether, phenyl glycidyl ether, o-cresyl glycidyl ether, m-p-cresyl glycidyl ether, glycidyl methacrylate, 1,6-hexanediol diglycidyl ether, trimethylolpropane polyglycidyl ether, hexahydrophthalic acid diglycidyl ester, hydrogenated bisphenol A diglycidyl ether, propylene glycol diglycidyl ether, tripropylene glycol diglycidyl ether, polypropylene glycol diglycidyl ether, fatty acid-modified epoxy, diethylene glycol diglycidyl ether, polyethylene glycol diglycidyl ether, glycerin polyglycidyl ether, diglycerin polyglycidyl ether, polyglycerin polyglycidyl ether, sorbitol polyglycidyl ether, 1,3,5-tris(2,3-epoxypropyl)-1,3,5-triazine, tetrahydrophthalic acid glycidyl ester, and glycidyl acrylate. In particular, from the viewpoint of coloration suppression and transparency, it is preferable to use polyglycidyl methacrylate, a copolymer of glycidyl methacrylate, tetrabromobisphenol A diglycidyl ether, hexahydrophthalic acid diglycidyl ester, hydrogenated bisphenol A diglycidyl ether, and the like. It is more preferable to use polyglycidyl methacrylate, a copolymer of glycidyl methacrylate, tetrabromobisphenol A diglycidyl ether, and the like, which have a boiling point of 200° C. or more and are solid at 50° C.

There is no particular limitation on the hydrotalcite-based heat stabilizer as long as it is a hydrotalcite compound. The hydrotalcite-based heat stabilizer may be a natural product or a synthetic product. It is possible to use ALCAMIZER (registered trademark) manufactured by Kyowa Chemical Industry Co., Ltd., and the like, for example.

There is no particular limitation on the tin-based stabilizer as long as it has a heat stabilizing effect. It is possible to use mercaptotin-based heat stabilizers such as dimethyltin mercapto, dimethyltin mercaptide, dibutyltin mercapto, dioctyltin mercapto, dioctyltin mercapto polymers, dioctyltin mercaptoacetate; maleate tin-based heat stabilizers such as dimethyltin maleate, dibutyltin maleate, dioctyltin maleate, and dioctyltin maleate polymers; and laurate-tin-based heat stabilizers such as dimethyltin laurate, dibutyltin laurate, and dioctyltin laurate, and the like.

There is no particular limitation on the Ca—Zn-based stabilizer as long as it has a heat stabilizing effect. It is possible to use zinc stearate, calcium stearate, zinc 12-hydroxystearate, calcium 12-hydroxystearate, and the like, for example.

There is no particular limitation on the β-diketone-based stabilizer as long as it has a heat stabilizing effect. It is possible to use stearoylbenzoylmethane (SBM), dibenzoylmethane (DBM), and the like, for example.

The stabilizers may be used alone or in combination of two or more.

From the viewpoint of coloration suppression and ensuring transparency while improving melt processability, it is preferable that the stabilizer may be at least one selected from the group consisting of polyglycidyl methacrylate, tetrabromobisphenol A diglycidyl ether, hydrotalcites, zinc 12-hydroxystearate, calcium 12-hydroxystearate, stearoylbenzoylmethane (SBM), and dibenzoylmethane (DBM).

The resin composition preferably contains the stabilizer in an amount of 0.1 parts by mass or more and 30 parts by mass or less, more preferably 0.2 parts by mass or more and 20 parts by mass or less, and even more preferably 0.5 parts by mass or more and 10 parts by mass or less with respect to 100 parts by mass of the total amount of the polymer (A) and the polymer (B). When the amount of the stabilizer is 0.1 parts by mass or more, a coloration suppression effect is favorable. Also, the amount of the stabilizer is 30 parts by mass or less, the coloration suppression effect is favorable, transparency can be ensured, and a deterioration in mechanical properties of the resin composition molded article is suppressed.

From the viewpoint of reducing friction between the polymer (A), the polymer (B), and a processing machine, reducing heat generation due to shear, and improving the fluidity and releasability, the resin composition may contain a lubricant within a range in which effects of the present invention are not impaired. It is possible to use, as the lubricant, fatty acid ester-based lubricants such as stearic acid monoglyceride and stearyl stearate, hydrocarbon-based lubricants such as liquid paraffin, paraffin wax, and synthetic polyethylene wax, fatty acid-based lubricants such as stearic acid, higher alcohol-based lubricants such as stearyl alcohol, aliphatic amide-based lubricants such as stearamide, oleamide, and erucamide, alkylene fatty acid amide-based lubricants such as methylene bis stearamide and ethylene bis stearamide, metal soap-based lubricants such as lead stearate, zinc stearate, calcium stearate, and magnesium stearate, and the like, for example. These may be used alone or in combination of two or more. The amount of lubricant added may be 10 parts by mass or less with respect to 100 parts by mass of the total amount of the polymer (A) and the polymer (B).

From the viewpoint of increasing spinnability, the resin composition may contain a processing aid. If fibers are to be made from the resin composition, the resin composition preferably contains a (meth)acrylate-based polymer and/or a styrene-acrylonitrile copolymer as a processing aid. It is possible to use, as a (meth)acrylate-based polymer, copolymers of (meth)acrylate and copolymer components such as butyl (meth)acrylate, isobutyl (meth)acrylate, 2-ethylhexyl (meth)acrylate, styrene, vinyl acetate, acrylonitrile, and the like. Also, it is possible to use, as a (meth)acrylate-based polymer, commercially-available polymers such as “KANE ACE PA20” and “KANE ACE PA101” manufactured by Kaneka Corporation, for example. It is sufficient that the amount of processing aid added is 10 parts by mass or less with respect to 100 parts by mass of the vinyl polymer. “(Meth)acrylate” refers to methacrylate or acrylate.

Method for Producing Resin Composition

The resin composition can be obtained by melt-kneading a powder mixture containing the polymer (A) and the polymer (B), for example. There is no particular limitation on the melt-kneading method, and a common method for melt-kneading a thermoplastic resin can be used.

Due to the ease of operation, first, the plasticizer is mixed into mixed powder of the polymer (A) and the polymer (B) to form a powder mixture. From the viewpoint of the ease of mixing, the moisture content of the polymer (A) and the polymer (B) is preferably 2 mass % or less, and more preferably 0.5 mass % or less. Note that the moisture content of the polymer (A) and the polymer (B) can be measured under the conditions of 160° C. and 10 minutes using a heat-drying moisture meter MX manufactured by A&D Company, Limited. Preferably, the stabilizer is mixed therein. Also, a lubricant, a processing aid, and the like are mixed as needed. Although there is no particular limitation on the mixing method, a mixer such as a Henschel mixer, a super mixer, a ribbon blender, or the like can be used. There is no particular limitation on the conditions such as the temperature, the time, and the like during the mixing operation as long as a powder mixture can be obtained. From the viewpoint of obtaining a powder mixture with ease and from the viewpoint of melting and causing various additives to adsorb on the surface of a mixed powder of the polymer (A) and the polymer (B), it is preferable that the temperature is set to a range of 0° C. or more and 120° C. or less during the mixing operation, and at the end of the mixing operation, the temperature is cooled to a temperature that is 10° C. lower than the glass transition temperature of the powder mixture such that the powder particles do not fuse to each other or to equipment such as pipes during transportation.

Then, the powder mixture is melt-kneaded. The temperature during kneading is more than or equal to the glass transition temperature of a kneaded material containing the polymer (A), the polymer (B), and the plasticizer, and from the viewpoint of suppressing coloration due to thermal decomposition of the polymer (A) and the polymer (B), the temperature during kneading is preferably 40° C. or more and 200° C. or less, more preferably 80° C. or more and 185° C. or less, and even more preferably 100° C. or more and 165° C. or less. There is no particular limitation on the kneading method, and it is possible to use kneading devices such as a single-screw extruder, a twin-screw extruder, a Plastomill, and a pressure kneader in kneading, for example. It is possible to obtain a lump-shaped, strand-shaped, or pellet-shaped resin composition by melt-kneading the powder mixture.

Synthetic Fibers

It is possible to produce modacrylic fibers using a resin composition obtained using a modacrylic resin as the polymer (A), and to produce vinyl chloride-based fibers using a resin composition obtained using polyvinyl chloride as the polymer (A). Specifically, in the case of modacrylic fibers, the modacrylic fibers can be obtained by melt-spinning a resin composition (e.g., a pellet-shaped resin composition obtained after melt-kneading) that contains the modacrylic resin. The same applies to vinyl chloride-based fibers, and vinyl chloride-based fibers can be obtained by melt-spinning a resin composition containing polyvinyl chloride. As for the modacrylic fibers, first, the resin composition is melt-spun into filament undrawn yarn. Specifically, a melt-kneaded material (pellet-shaped resin composition) obtained by melt-kneading a resin composition using an extruder such as a single-screw extruder, a counter-rotating twin-screw extruder, or a conical twin-screw extruder, is extruded from a spinning nozzle in the extruder, and allowed to pass through a heating cylinder, and the temperature is raised such that a fibrous resin composition can be taken up by a winder, and then taken up while cooling the temperature to a glass transition point thereof or less through air cooling, wind cooling, or the like, and thereby an undrawn yarn can be formed. The extruder is preferably operated in a temperature range of 120° C. or more and 200° C. or less, for example. There is no particular limitation on a ratio of the taking up speed to the extruding speed, and it is preferable to take up the composition at a speed ratio in a range of 1-fold to 100-fold, and from the view point of spinning stability, it is more preferable to take up the composition at a speed ratio in a range of 5-fold to 50-fold, for example. There is no particular limitation on the diameter of the spinning nozzle, and the diameter of the spinning nozzle is preferably 0.05 mm or more and 2 mm or less, and more preferably 0.1 mm or more and 1 mm or less, for example. It is preferable to extrude the composition at a temperature that is higher than or equal to the nozzle temperature at which the material extruded from the spinning nozzle does not generate a melt fracture. The temperature of the spinning nozzle is preferably 160° C. or more, and more preferably 170° C. or more. The temperature of the heating cylinder is preferably 200° C. or more, and more preferably 230° C. or more. The cooling temperature is preferably −196° C. or more and 40° C. or less and more preferably 0° C. or more and 30° C. or less for air cooling, and preferably 5° C. or more and 60° C. or less and more preferably 10° C. or more and 40° C. or less for water cooling.

The undrawn yarn obtained above can be subjected to drawing treatment using a known method, and if necessary, thermal relaxation treatment. If the modacrylic fibers is used as artificial hair, for example, the modacrylic fibers is preferably formed into fibers (filaments) having a single fiber fineness of 2 dtex or more and 100 dtex or less. The drawing conditions are such that, in a dry heat atmosphere at a drawing temperature of 70° C. or more and 150° C. or less, the draw ratio is preferably about 1.1-fold or more and about 6-fold or less, and about 1.5-fold or more and about 4.5-fold or less. The drawn yarn are subjected to thermal relaxation treatment, preferably at a relaxation ratio of 1% or more and 50% or less, more preferably 5% or more and 40% or less, thus reducing thermal shrinkage. It is preferable to perform thermal relaxation treatment in order to adjust irregularities on the fiber surface and achieve a smooth texture similar to that of human hair. Also, the fineness can be controlled by washing the undrawn yarn or drawn yarn with water. In the present invention, single fiber fineness can be measured in conformity with JIS L 1013.

An apparent glass transition temperature of the modacrylic fibers (heat-treated yarn) obtained above is preferably 60° C. or more because the indoor temperature may increase to 60° C. in an onboard container during overseas transportation, and from the viewpoint of preventing fusion between fibers during heat treatment.

Synthetic fibers such as modacrylic fibers can be dyed with a dye (C), in particular, a dyeing agent containing an acidic dye, and are easily dyeable with acidic dyes.

Hair Ornament Product

Because the synthetic fibers have a favorable texture, high dyeability, and high dyeability with a dyeing agent containing, in particular, an acidic dye such as an acidic dyeing agent for human hair, the synthetic fibers can be suitably used as artificial hair for hair ornament products. The synthetic fibers may be used alone as artificial hair, or may be used in combination with other fibers for artificial hair.

The hair ornament product preferably is, but is not limited to, one selected from the group consisting of hair wigs, wigs, weaving, hair extensions, braided hair, hair accessories, and doll hair.

Because the hair ornament product contains synthetic fibers that are easily dyeable with acidic dyes, it is possible to dye the hair ornament product using a human hair dyeing agent containing acidic dye in a desired color.

### EXAMPLES

Although the present invention will be described below in detail using examples, the present invention is not limited to the following examples.

Dyeability

The dyeability of fibers and/or resin composition was evaluated using the following method. An acidic dyeing agent for human hair (product name “Express Color Semi-Permanent #108 Black” manufactured by Kiss Products Inc.) was applied to the fibers and/or resin composition, the fibers and/or resin composition was left at room temperature (25±5° C.) for 25 minutes, washed with ion-exchanged water and an aqueous emulsion (Score Roll 700: 5 g/L) of nonionic surfactant (product name “Score Roll 700” manufactured by Hokko Chemical Co., Ltd.) and dried, and a color change was visually evaluated according to the criteria.

1: not dyed at all

2: slightly dyed

3: dyed

4: dyed well

### Compatibility

10 mg of the polymer (A) and 2 g of a plasticizer were introduced into a 19 mL glass tube made of borosilicate, the glass tube was sealed with a silicon stopper, and the mixture was heated at 160° C. for 30 minutes while being stirred occasionally, and whether or not the polymer (A) was dissolved was observed.

Solubility

0.1 g of the polymer (B) was introduced into 5 mL of benzyl alcohol and stirred at room temperature (25±5° C.) for 1 hour, and whether or not the polymer (B) was dissolved was observed.

### Production Example 1

A modacrylic resin was produced as the polymer (A). 54 parts by mass of vinyl chloride, 7.5 parts by mass of acrylonitrile, 3 parts by mass of poly(acrylic acid 2-methoxyethyl) macromonomer having a acryloyl group in one terminal of its, 210 parts by mass of ion-exchanged water, 0.4 parts by mass of partially saponified polyvinyl acetate (the degree of saponification was about 70 mol %, the number-average degree of polymerization was 1700), 0.75 parts by mass of 1,1,3,3-tetramethylbutyl peroxyneodecanoate were introduced into a polymerization reactor, and the resulting mixture was stirred and dispersed for 15 minutes in a state in which the internal temperature of the polymerization reactor was cooled to 15° C. or less. Then, the internal temperature of the polymerization reactor was increased to 50° C. so as to initiate polymerization, and suspension polymerization was carried out at a polymerization temperature of 50° C. for 4 hours, the polymerization temperature was increased to 52.5° C. and suspension polymerization was carried out for an additional 2 hours, and the polymerization temperature was increased to 55° C. and suspension polymerization was carried out for an additional 2 hours. During polymerization, 35.5 parts by mass of acrylonitrile and 0.7 parts by mass of 2-mercaptoethanol were continuously added at a constant speed from immediately after the initiation of the polymerization until the seventh hour. Unreacted vinyl chloride monomer was collected from the polymerization reactor, and slurry was removed therefrom. The obtained slurry was dehydrated and dried using a hot-air dryer at 60° C. for 24 hours, and thereby a modacrylic resin was obtained. The obtained modacrylic resin contained acrylonitrile in an amount of 40.7 mass %, vinyl chloride in an amount of 56.3 mass %, and poly(acrylic acid 2-methoxyethyl) in an amount of 3.0 mass %, and had a mass average molecular weight of approximately 39000.

Also, the compatibility was evaluated as described above, and it was confirmed that the modacrylic resin obtained in Production Example 1 had compatibility with dimethyl sulfone.

### Example 1

2.5 parts by mass of dimethyl sulfone used as a plasticizer, 6.98 parts by mass of a stabilizer, 0.384 parts by mass of a lubricant, and 3 parts by mass of a processing aid were added to the total amount of 100 parts by mass of 90 parts by mass of the modacrylic resin obtained in Production Example 1 and 10 parts by mass of poly(vinyl acetate) (the number-average degree of polymerization was 500 manufactured by Kishida Chemical Co., Ltd.) used as the polymer (B), the resulting mixture was mixed using a mixer, and thus a powder mixture was obtained. Then, a resin composition was obtained by kneading 62 g of the powder mixture at 115° C. and 50 rpm for 10.5 minutes using a Lab Plastomill (model “4C₁₅₀” manufactured by Toyo Seiki Co., Ltd.)

### Example 2

A resin composition was obtained in a similar manner to that of Example 1, except that poly(vinyl acetate) (the number-average degree of polymerization was 2000 manufactured by FUJIFILM Wako Pure Chemical Corporation) was used instead of poly(vinyl acetate) (the number-average degree of polymerization was 500).

### Example 3

2.5 parts by mass of dimethyl sulfone used as a plasticizer, 6.98 parts by mass of a stabilizer, 0.384 parts by mass of a lubricant, and 3 parts by mass of a processing aid were added to the total amount of 100 parts by mass of 80 parts by mass of the modacrylic resin obtained in Production Example 1 and 20 parts by mass of vinylpyrrolidone-vinyl acetate copolymer (40 mass % of vinyl acetate and 60 mass % of vinylpyrrolidone, the mass average molecular weight was 65000) used as the polymer (B), the resulting mixture was mixed using a Henschel mixer, and thus a powder mixture was obtained. Then, the powder mixture was extruded using a lab extruder (model number “4C150” manufactured by Toyo Seiki Co., Ltd., a combination of a 20 mm extrusion unit and a 2 mm strand nozzle), and thus strands were obtained. The extruder was operated within a temperature range of 120° C. to 150° C. The obtained strands were air-cooled and formed into pellets so as to obtain resin composition pellets.

The resin composition pellets obtained above were extruded and melt-spun at a cylinder temperature of 140° C. to 160° C. and a nozzle temperature of 230° C., using a laboratory extruder (model number “4C150” manufactured by Toyo Seiki Co., Ltd., a combination of a 20 mm extrusion unit, a downward die for melt viscosity measurement, and a cocoon-type spinning nozzle with a hole cross-sectional area of 0.0793 mm² and 12 holes). The resin composition was taken up at a nozzle draft of approximately 5-fold so as to obtain undrawn yarn with a fineness of 200 dtex. The obtained undrawn yarn was dry-heat-drawn at a draw ratio of 3-fold in a dry-heat atmosphere at 105° C. so as to obtain fibers with a single fiber fineness of approximately 70 dtex.

### Example 4

Resin composition pellets were obtained in a manner similar to that of Example 3, except that poly(glycidyl methacrylate) (the mass average molecular weight was 10000, product name “Marproof G-01100” manufactured by NOF Corporation) was used as the polymer (B) instead of a vinylpyrrolidone-vinyl acetate copolymer.

Melt-spinning was performed in a manner similar to that of Example 3, except that the resin composition pellets obtained above were used. The resin composition was taken up at a nozzle draft of approximately 5-fold so as to obtain undrawn yarn with a fineness of 200 dtex. The obtained undrawn yarn was dry-heat-drawn at a draw ratio of 3-fold in a dry-heat atmosphere at 105° C. so as to obtain fibers with a single fiber fineness of approximately 70 dtex.

### Example 5

Resin composition pellets were obtained in a manner similar to that of Example 3, except that an acrylonitrile-styrene copolymer (product name “BLENDEX 5433” manufactured by Galata Chemicals, containing acrylonitrile in an amount of 30 mass % and styrene in an amount of 70 mass %, the mass average molecular weight was 86000) was used as the polymer (B) instead of the vinylpyrrolidone-vinyl acetate copolymer.

Melt-spinning was performed in a manner similar to that of Example 3, except that the resin composition pellets obtained above were used. The resin composition was taken up at a nozzle draft of approximately 5-fold so as to obtain undrawn yarn with a fineness of 200 dtex. The obtained undrawn yarn was dry-heat-drawn at a draw ratio of 3-fold in a dry-heat atmosphere at 105° C. so as to obtain fibers with a single fiber fineness of approximately 70 dtex.

### Example 6

Resin composition pellets were obtained in a manner similar to Example 3, except that poly(vinyl acetate) (the number-average degree of polymerization was 500; manufactured by Kishida Chemical Co., Ltd.) was used as the polymer (B) instead of the vinylpyrrolidone-vinyl acetate copolymer, and a total amount of 100 parts by mass of 90 parts by mass of the modacrylic resin obtained in Production Example 1 and 10 parts by mass of poly(vinyl acetate) was used.

Melt-spinning was performed in a manner similar to that of Example 3, except that the resin composition pellets obtained above were used. The resin composition was taken up at a nozzle draft of approximately 5-fold so as to obtain undrawn yarn with a fineness of 200 dtex. The obtained undrawn yarn was dry-heat-drawn at a draw ratio of 3-fold in a dry-heat atmosphere at 105° C. so as to obtain fibers with a single fiber fineness of approximately 70 dtex.

### Comparative Example 1

A resin composition was obtained in a manner similar to that of Example 1, except that the amount of the modacrylic resin obtained in Production Example 1 was 100 parts by mass and poly(vinyl acetate) was not used.

### Comparative Example 2

A resin composition was obtained in a manner similar to that of Example 1, except that the amount of the modacrylic resin obtained in Production Example 1 was changed to 95 parts by mass and the amount of poly(vinyl acetate) (the number-average degree of polymerization was 500) was changed to 5 parts by mass.

### Comparative Example 3

A resin composition was obtained in a manner similar to that of Example 2, except that the amount of the modacrylic resin obtained in Production Example 1 was changed to 95 parts by mass and the amount of poly(vinyl acetate) (the number-average degree of polymerization was 2000) was changed to 5 parts by mass.

### Comparative Example 4

Resin composition pellets were obtained in a manner similar to that of Example 3, except that the amount of the modacrylic resin obtained in Production Example 1 was 100 parts by mass and the vinylpyrrolidone-vinyl acetate copolymer was not used.

Melt-spinning was performed in a manner similar to that of Example 3, except that the resin composition pellets obtained above were used. The resin composition was taken up at a nozzle draft of approximately 6.8-fold so as to obtain undrawn yarn with a fineness of 150 dtex. The obtained undrawn yarn was dry-heat-drawn at a draw ratio of 3-fold in a dry-heat atmosphere at 105° C. so as to obtain fibers with a single fiber fineness of approximately 48 dtex.

The solubility of the polymers (B) used in the examples and comparative examples, specifically, poly(vinyl acetate) having a number-average degree of polymerization of 500, poly(vinyl acetate) having a number-average degree of polymerization of 2000, the vinylpyrrolidone-vinyl acetate copolymer, poly(glycidyl methacrylate), and the acrylonitrile-styrene copolymer to benzyl alcohol were evaluated as described above, and the results were listed in Table 1 below.

The dyeability of the resin compositions or the fibers obtained in Examples 1 to 6 and Comparative Examples 1 to 4 were evaluated as described above, and the results were listed in Table 2 below.

TABLE 1

| | Solubility to Benzyl |
|---|---|
| Polymer (B) | Alcohol |
| Poly(vinyl acetate) (with number-average degree of | Soluble |
| polymerization of 500) | |
| Poly(vinyl acetate) (with number-average degree of | Soluble |
| polymerization of 2000) | |
| Vinylpyrrolidone-vinyl acetate copolymer | Soluble |
| Poly(glycidyl methacrylate) | Soluble |
| Acrylonitrile-styrene copolymer | Soluble |

TABLE 2

| Ex./ | | Polymer (A) | | Polymer (B) | | |
|---|---|---|---|---|---|---|
| Comp. | | | parts | | parts | |
| Ex. | Form | Polymer Type | by mass | Polymer Type | by mass | Dyeability |
| Ex. 1 | Resin | Modacrylic Resin | 90 | Poly(vinyl acetate) | 10 | 2 |
| | composition | (Production Ex. 1) | | (with number-average | | |
| | | | | degree of polymerization | | |
| | | | | of 500) | | |
| Ex. 2 | Resin | Modacrylic Resin | 90 | Poly(vinyl acetate) | 10 | 2 |
| | composition | (Production Ex. 1) | | (with number-average | | |
| | | | | degree of polymerization | | |
| | | | | of 2000) | | |
| Ex. 3 | Fibers | Modacrylic Resin | 80 | Vinylpyrrolidone-vinyl | 20 | 4 |
| | | (Production Ex. 1) | | acetate copolymer | | |
| Ex. 4 | Fibers | Modacrylic Resin | 80 | Poly(glycidyl | 20 | 3 |
| | | (Production Ex. 1) | | methacrylate) | | |
| Ex. 5 | Fibers | Modacrylic Resin | 80 | Acrylonitrile-styrene | 20 | 2 |
| | | (Production Ex. 1) | | copolymer | | |
| Ex. 6 | Fibers | Modacrylic resin | 90 | Poly(vinyl acetate) | 10 | 2 |
| | | (Production Ex. 1) | | (with number-average | | |
| | | | | degree of polymerization | | |
| | | | | of 500) | | |
| Comp. | Resin | Modacrylic Resin | 100 | — | 0 | 1 |
| Ex. 1 | composition | (Production Ex. 1) | | | | |
| Comp. | Resin | Modacrylic Resin | 95 | Poly(vinyl acetate) | 5 | 1 |
| Ex. 2 | composition | (Production Ex. 1) | | (with number-average | | |
| | | | | degree of polymerization | | |
| | | | | of 500) | | |
| Comp. | Resin | Modacrylic Resin | 95 | Poly(vinyl acetate) | 5 | 1 |
| Ex. 3 | composition | (Production Ex. 1) | | (with number-average | | |
| | | | | degree of polymerization | | |
| | | | | of 2000) | | |
| Comp. | Fibers | Modacrylic Resin | 100 | — | 0 | 1 |
| Ex. 4 | | (Production Ex. 1) | | | | |

Based on the results in Table 1 and Table 2, it was found that the resin compositions or synthetic fibers of Examples 1 to 6 that contained the polymer (A) and the polymer (B) that is soluble in benzyl alcohol in predetermined amounts were dyed with a dyeing agent for human hair containing an acidic dye.

On the other hand, the resin compositions or fibers of Comparative Examples 1 to 4 that did not contain the polymer (B) that is soluble in benzyl alcohol or contained a little amount of the polymer (B) that is soluble in benzyl alcohol were not dyed with the dyeing agent for human hair containing the acidic dye.

The present invention includes, but is not particularly limited to, one or more embodiments below, for example.
(1) A resin composition containing a polymer (A) and a polymer (B),
in which the polymer (A) is a polymer that includes one or more monomer units selected from the group consisting of acrylonitrile, a vinyl halide, and a vinylidene halide,
the polymer (B) is a polymer that is soluble in benzyl alcohol, and
the resin composition contains the polymer (A) in an amount of 70 parts by mass or more and 92.5 parts by mass or less, and the polymer (B) in an amount of 7.5 parts by mass or more and 30 parts by mass or less, where a total amount of the polymer (A) and the polymer (B) is 100 parts by mass.
(2) The resin composition according to (1), in which the polymer (B) is a polymer that includes one or more monomer units selected from the group consisting of vinyl acetate, vinylpyrrolidone, acrylic acid esters, methacrylic acid esters, and styrene.
(3) The resin composition according to (1) or (2), in which the polymer (B) includes one or more selected from the group consisting of a homopolymer of vinyl acetate, a copolymer of vinylpyrrolidone and vinyl acetate, a copolymer of acrylonitrile and styrene, and poly(glycidyl methacrylate).
(4) The resin composition according to any one of (1) to (3), in which the polymer (A) is a modacrylic resin.
(5) The resin composition according to (4), in which the modacrylic resin is a copolymer of acrylonitrile, one or more halogenated monomers selected from the group consisting of a vinyl halide and a vinylidene halide, and a macromonomer having, in a main chain, a double bond-containing ethylenically unsaturated monomer.
(6) The resin composition according to any one of (1) to (3), in which the polymer (A) is a polyvinyl chloride.
(7) A method for dyeing a resin composition, including coloring the resin composition according to any one of (1) to (6) by impregnating the resin composition with a dyeing agent containing a dye (C) and an alcohol.
(8) The method for dyeing a resin composition according to (7), in which the alcohol is benzyl alcohol.
(9) The method for dyeing a resin composition according to (7) or (8), in which the dye (C) is an acidic dye.
(10) A synthetic fiber containing the resin composition according to any one of (1) to (6).
(11) A method for producing synthetic fibers, including a step of melt-spinning the resin composition according to any one of (1) to (6).
(12) A hair ornament product containing the synthetic fiber according to (10).

1. A resin composition comprising:
a polymer (A); and
a polymer (B),
wherein the polymer (A) is a modacrylic resin, and the modacrylic resin is a copolymer of acrylonitrile, one or more halogenated monomers selected from the group consisting of a vinyl halide and a vinylidene halide, and a macromonomer having, in a main chain, a polymer composed of a double bond-containing ethylenically unsaturated monomer,
the polymer (B) is a polymer that is soluble in benzyl alcohol, and the polymer (B) is a polymer that comprises one or more monomer units selected from the group consisting of vinyl acetate, vinylpyrrolidone, acrylic acid esters, methacrylic acid esters, and styrene, and
the resin composition comprises the polymer (A) in an amount of 70 parts by mass or more and 92.5 parts by mass or less, and the polymer (B) in an amount of 7.5 parts by mass or more and 30 parts by mass or less, where a total amount of the polymer (A) and the polymer (B) is 100 parts by mass.

2. (canceled)

3. The resin composition according to claim 1,
wherein the polymer (B) comprises one or more selected from the group consisting of a homopolymer of vinyl acetate, a copolymer of vinylpyrrolidone and vinyl acetate, a copolymer of acrylonitrile and styrene, and poly(glycidyl methacrylate).

4-6. (canceled)

7. A method for dyeing a resin composition, comprising
coloring the resin composition according to claim 1 by impregnating the resin composition with a dyeing agent containing at least a dye (C) and an alcohol.

8. The method for dyeing a resin composition according to claim 7,
wherein the alcohol is benzyl alcohol.

9. The method for dyeing a resin composition according to claim 7,
wherein the dye (C) is an acidic dye.

10. A synthetic fiber comprising the resin composition according to claim 1.

11. A method for producing synthetic fibers, comprising
melt-spinning the resin composition according to claim 1.

12. A hair ornament product comprising
at least the synthetic fiber according to claim 10.

13. The resin composition according to claim 1,
wherein the macromonomer has at least one reactive functional group per molecule arranged at an end of the molecule, the reactive functional group having a polymerizable carbon-carbon double bond represented by general formula (1) below,
CH₂═C(R)—C(O)O— (1)
wherein in the general formula (1), R represents hydrogen or a substituted or unsubstituted alkyl group having 1 to 20 carbon atoms.

14. The resin composition according to claim 1,
wherein the double bond-containing ethylenically unsaturated monomer in the main chain of macromonomer is one or more selected from the group consisting of (meth)acrylic acid ester-based monomers, styrene-based monomers, nitrile group-containing vinyl-based monomers, amide group-containing vinyl-based monomers, silicon-containing vinyl monomers, maleimide-based monomers, vinyl esters, alkenes, conjugated dienes, maleic anhydride, maleic acid, monoalkyl esters of maleic acid, dialkyl esters of maleic acid, fumaric acid, monoalkyl esters of fumaric acid, dialkyl esters of fumaric acid, allyl chloride, and allyl alcohol.

15. The resin composition according to claim 1,
wherein the modacrylic resin comprise the acrylonitrile in an amount of 35 parts by mass or more and 64 parts by mass or less, the halogenated monomer in an amount of 35 parts by mass or more and 64 parts by mass or less, and the macromonomer in an amount of 1 part by mass or more and 30 parts by mass or less, where a total mass of the acrylonitrile, the halogenated monomer, and the macromonomer is 100 parts by mass.

16. The resin composition according to claim 1,
wherein the polymer (B) comprises one or more selected from the group consisting of a homopolymer of vinyl acetate, a copolymer of vinylpyrrolidone and vinyl acetate, and a copolymer of acrylonitrile and styrene.

17. The hair ornament product according to claim 12,
wherein the hair ornament product comprises one selected from the group consisting of hair wigs, wigs, weaving, hair extensions, braided hair, hair accessories, and doll hair.
